(19) United States
(12) Patent Application Publication
(10) Pub. No.: US 2004/0235423 A1
(43) Pub. Date: Nov. 25, 2004

(54) Method and apparatus for network management using perceived signal to noise and interference indicator

(75) Inventors: Joseph Kwak, Bolingbrook, IL (US); Stephen G. Dick, Nesconset, NY (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE

(21) Appl. No.: 10/729,332

(22) Filed: Dec. 5, 2003

Related U.S. Application Data
(60) Provisional application No. 60/440,073, filed on Jan. 14, 2003.

(51) Int. Cl. H04B 1/10; H04B 15/00

(52) U.S. Cl. 455/67.13; 455/67.11

(57) ABSTRACT

Method and apparatus of network management using a perceived signal to noise indicator (PSNI), in preference to received signal strength indicator to provide physical layer measurements in a multitude of stations in the network, either by way of radio frequency power, or observed signal to noise plus interference from each access point, to report the measurements, to collect the measurements, and using the reported PSNI values as a signal quality indicator of delivered bit error rate or frame error rate to evaluate, reconfigure, and manage multiple stations in order to optimize the network or network performance.

### CROSS REFERENCE TO RELATED APPLICATION(S)

This application claims priority from U.S. Provisional Application No. 60/440,073 and filed on Jan. 14, 2003, which is incorporated by reference as if fully set forth herein.

### FIELD OF THE INVENTION

The present invention relates generally to network management, and more particularly to facilitating network management using a parameter of an observed signal obtained at a receiving location, which parameter serves as a perceived signal to noise (and interference) indicator (PSNI).

### BACKGROUND

This specification includes the following acronyms:

| | |
|---|---|
| AP | access point |
| BER | bit error rate |
| CCK | complementary code keying (RF modulation) |
| DSSS | direct sequence spread spectrum |
| EIRP | equivalent isotropically radiated power |
| ERP | effective radiated power |
| FEC | forward error correction |
| FER | frame error rate |
| MIB | management information base |
| OFDM | orthogonal frequency division multiplexing |
| PBCC | packet binary convolution coding |
| PHY | physical layer |
| PLCP | physical layer conversion protocol |
| PMD | physical medium dependent |
| PPDU | PLCP protocol data unit |
| PSK | phase shift keying |
| PSNI | perceived signal to noise indication |
| RPI | received power indicator |
| RSSI | received signal strength indicator |
| SQ | signal quality |
| STA | station |

The current IEEE standard 802.11 is entrusted with the task of providing interfaces, measurements, and mechanisms to support higher layer functions for efficient network management. Presently, the 802.11 standard has defined several physical parameters, none of which is completely suitable for network management purposes. One example of a measurable parameter is received signal strength indicator (RSSI), which is a reportable parameter for each received frame but is not quantified in the standards, and is not fully specified. The standards do include certain definitions in the context of RSSI, but it remains that RSSI poses certain limitations for use in network management since RSSI parameters from different stations (STAs) may not be uniformly defined and thus are not comparable.

A second suggested measurable parameter is the signal quality (SQ), which also happens to be an unquantized indicator of code synchronization, but is only applicable to the DSSS PHY modulation and is not applicable to OFDM PHY modulations. Yet another measurable parameter is the RPI histogram, which, even though quantized and specified, cannot make target measurements on any AP. RPI histograms measure channel power from all sources including the 802.11 sources, radars, and all other interference sources, which is not helpful for relying on the RPI histogram as a controlling parameter.

Current standards define received signal strength indication based mainly on measurement of AP signals:

(1) on the same channel, same physical layer, and same station; and

(2) on different channels, same physical layer, and same station.

Significantly, measurements involving different physical layers and the same or different stations, even though required, are not presently addressed in the standards.

Network management needs comparative PHY measurements for use in handoff decisions, for example. The following types of comparative PHY measurements are made.

1. To compare AP signals on the same channel, the same PHY, in the same STA.

2. To compare AP signals on the same channel, the same PHY, in different STAs.

3. To compare AP signals on different channels, the same PHY, in the same STA.

4. To compare AP signals on different channels, the same PHY, in different STAs.

5. To compare AP signals on different PHYs in different STAs.

6. To compare AP signals on different PHYs in the same STA. Comparative measurements are crucial to handoff decisions for Network Management.

RSSI, as currently defined, only addresses categories (1) and (3) above. The RSSI is a measure of the RF energy received by the DSSS PHY or the OFDM PHY. RSSI indications of up to eight bits (256 levels) are supported. The allowed values for RSSI range from 0 through RSSI maximum. This parameter is a measure by the PHY sublayers of the energy observed at the antenna used to receive the current PPDU. RSSI is measured during the reception of the PLCP preamble. RSSI is intended to be used in a relative manner, and it is a monotonically increasing function of the received power.

CCK, ER-PBCC: the 8-bit value of RSSI as described in 18.4.5.11.

ERP-OFDM, DSSS-OFDM, the 8 bit value is in the range of 0 to RSSI maximum as described in 17.2.3.2.

Some limitations of the RSSI indicator are: RSSI is a monotonic, relative indicator of power at the antenna connector, which indicates sum of desired signal, noise, and interference powers. In high interference environments, RSSI is not an adequate indicator of desired signal quality. RSSI is not fully specified: there are no unit definitions and no performance requirements (accuracy, fidelity, testability). Since so little about RSSI is specified, it must be assumed that widely variant implementations already exist. It is not possible to compare RSSIs from different products and perhaps not even from different channels/bands within the same product.

Although RSSI has limited use for evaluating AP options within a given PHY, it is not useful in comparing different PHYs. RSSI must be rescaled for DSSS and OFDM PHYs. RSSI is clearly not useable by network management for load balancing or load shifting and RSSI from one STA does not relate to RSSI from any other STA.

### SUMMARY

The invention provides a network management method using a parameter of a signal which serves as perceived signal to noise indication (PSNI), in preference to RSSI which latter indication has several serious limitations. Preferably, but necessarily, the allowed values for the PSNI parameter, for example, may be in the range of 0 to 255.

### BRIEF DESCRIPTION OF THE DRAWING(S)

A more detailed understanding of the invention may be had from the following description of preferred embodiments, given by way of example and to be understood in conjunction with the accompanying drawings wherein:

FIG. 1 shows the options for PHY measurements;

FIG. 1a is a flow diagram showing a technique for deriving an input to the FEC decoder;

FIG. 2 shows PSNI specified on BER curves; and

FIG. 3 shows example PSNI specification points.

### DETAILED DESCRIPTION OF THE PREFERRED EMBODIMENT(S)

It is desirable to provide a method of network management, considering comparative measurements of AP signals in all varying situations including different physical layers and the same or different stations.

Described hereinafter is a demodulator-specific, subjective estimator of perceived S/(N+I) specified by means of a quantized FER indication. The following is noted in the context of the description of the exemplary embodiment.

All digital demodulators use tracking loops and complex post-processing to demodulate received symbols. Many internal demodulator parameters are proportional to perceived S/(N+I). Some examples are:

PSK: baseband phase jitter, base band Error Vector Magnitude (EVM)

DSSS: spreading code correlation quality

OFDM: frequency tracking and channel tracking stability

Demodulator internal parameters are available on a frame-by-frame basis. Demodulator parameters proportional to analog S/(N+I) are invariant with respect to data rates. The same parameter may be used at any data rate.

Demodulator internal parameters may be specified and calibrated in a controlled environment with respect to actual FER performance at two or more operating points defined by rate, modulation, and FEC. Such demodulator internal parameters estimate FER performance in both interference environments and interference-free (noise only) environments and may be used as the basis for PSNI. For PSNI to be a useful indicator it is not necessary to specify which demodulator internal parameter to use as the basis for the indicator, but it is sufficient to only specify how the quantized indicator relates to FER.

The following features are to be noted in connection with the inventive use of PSNI for network management:

PSNI is specified like RSSI as an 8-bit unsigned value, monotonically increasing with increasing S/(N+I).

PSNI is logarithmically scaled to perceived S/(N+I). PSNI is based on a demodulator internal parameter which provides a fast estimator for FER.

Specify PSNI output indication across a range defined by two signal quality points: first point at a minimum useable signal quality level, second point at a maximum signal quality level.

Specify the output value and accuracy of the output value for at least two FER points, and at least one FER point for each valid modulation, FEC, and data rate combination.

PSNI range may span the lower 40 db portion of the operating range of S/(N+I) to cover high FERs at data rates from 1 to 54 Mbps, but higher or lower range spans may be used.

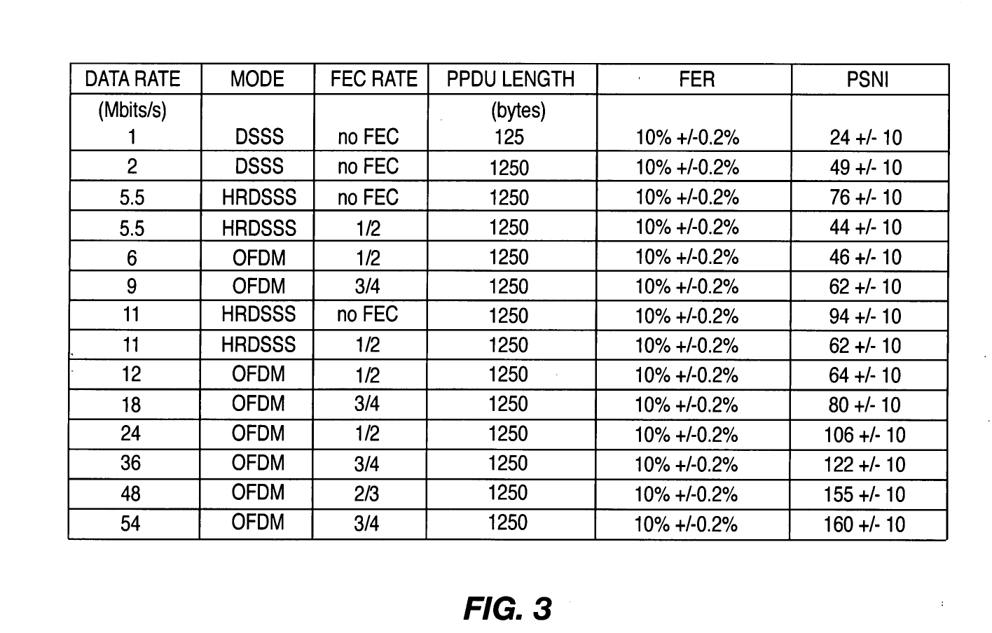

The PSNI indicator is a measure of the perceived, post-processing signal-to-noise-plus-interference (S/(N+I)) ratio in the demodulator. The allowed values for the Perceived Signal to Noise Indicator (PSNI) parameter are in the range from 0 through 255 (i.e., eight binary bits). This parameter is a measure by the PHY sublayer of the perceived signal quality observed after RF downconversion, and is derived from internal digital signal processing parameters of a demodulator used to receive the current frame. PSNI is measured over the PLCP preamble and over the entire received frame. PSNI is intended to be used in a relative manner, and it is a monotonically increasing, logarithmic function of the observed S/(N+I). PSNI accuracy and range are specified at a minimum of two different FER operating conditions. FIG. 3 supplies example specification points for a PSNI scaled to a 43 dB range.

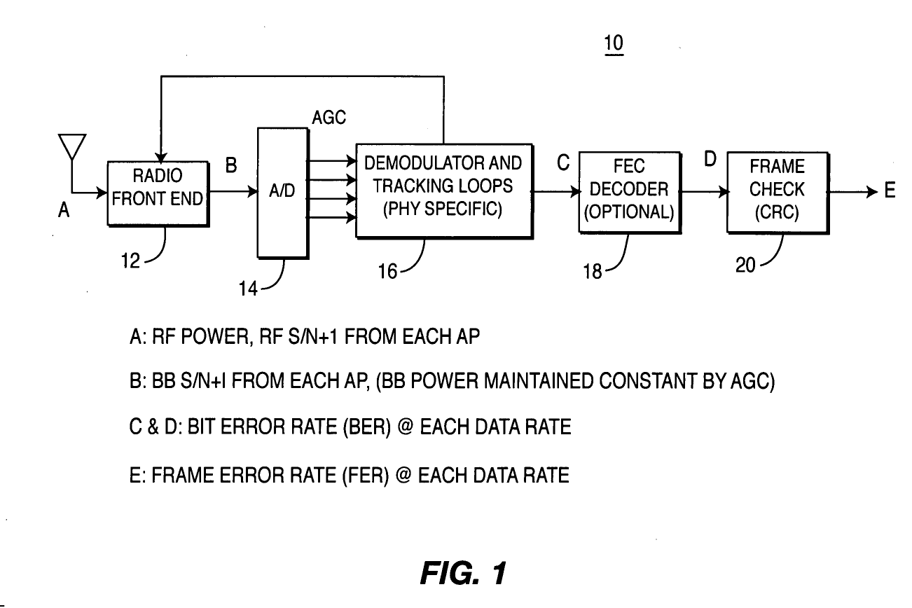

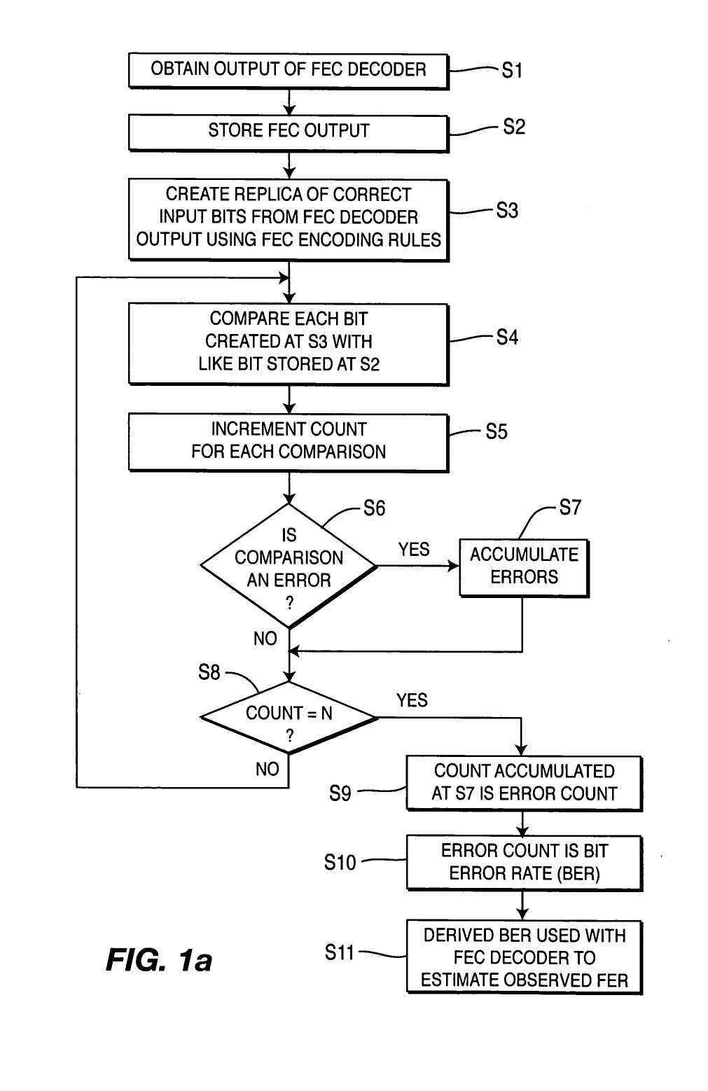

FIG. 1 shows the options for PHY measurements, which can be used for a PSNI indicator. Referring to the receiver 10 in FIG. 1, the following general comments are valid for a wide range of modern modulation and coding techniques. The signal to noise ratio at points A and B are nominally the same and may differ slightly due to added losses in the radio front end 12. The signal to noise ratio after the analog to digital conversion at A/D converter 14 is also nominally the same value, with minor additions to the noise associated with quantization error.

Therefore, in a high performance system, there is only a minor difference between the signal to noise ratio at point A and that at the input to demodulator 16 and tracking loops. In a low complexity and low performance system, the signal to noise ratio difference between point A and the input to demodulator 16 may be significant. The signal to noise ratio at the output of demodulator 16 (point C) is only indirectly observable by means of the bit error rate (BER). The BER at point C relates to the signal to noise ratio at point B according to a theoretical demodulation performance curve which is adjusted to account for actual demodulator implementation losses.

Similarly, the BER at the output of FEC decoder 18 (point D) relates to the FEC decoder input according to a theoretical FEC decoder performance curve which is adjusted to account for actual FEC decoder implementation losses. The frame error rate (FER) at point E at the output of the frame check function 20 is a direct mathematical function of the BER and the error distribution statistics at point D. There are normally no implementation losses associated with the frame check. In general, for low BERs, the FER is equal to the BER multiplied by the frame size in bits.

The frame check function 20 of receiver 10 in FIG. 1 may be implemented with or without a frame parity check. In most practical designs, each frame contains a parity check, which indicates (with high reliability) whether the block was received correctly or not. The most common parity check is a cyclic redundancy check (CRC), but other techniques are possible and acceptable. If no frame parity check is used, the FER may be estimated using a derived BER from the functioning of the FEC decoder 18. Deriving the BER input from the FEC decoder 18 may be obtained using a well known process, summarized as follows (see FIG. 1a):

The output of the FEC decoder is generally correct. Therefore, this output is obtained and stored (steps S1 and S2). The FEC encoding rules are used to create a replica of the correct input bits (step S3) and each bit is compared to the corresponding bit that was actually input to the FEC decoder and stored (step S4). A count is increased for each comparison (step S5). Each disagreement (step S6) represents an input bit error (step S7) which is accumulated. This derived BER (steps S9, S10) may then be used with the actual performance curve of the FEC decoder to estimate observed FER (step S11). The comparisons (error or no error—step S6) are continued until a count N is reached (step S8), at which time the count at step S7 is identified as the BER (step S9).

In this way, using the actual implementation losses with the theoretical performance curves allows one to relate the signal to noise measurements at any point to the signal to noise measurement at any other point.

From a network management point of view, the signal quality delivered to the user is best represented by the actual FER or observed FER (point E). The PSNI concept provides an indicator which directly relates to observed FER for all STAs, regardless of each STA's different implementation loss. This is accomplished by 1) basing the PSNI on the measurement of an internal demodulator parameter, 2) specifying the PSNI indicator values with respect to observed FER at particular data rate/demodulation/FEC combination points, and 3) adjusting the internal demodulator parameter measurement to account for actual FEC decoder losses which occur downstream from the measurement point. By using a measurement point internal to the demodulator, the measured signal quality already includes the effects of the STA front end losses. By specifying the PSNI indicator with respect to observed FER, actual demodulator losses are included. By adjusting the demodulator measurement to account for actual FEC decoder losses, the validity of the indicator is preserved for all FEC decoders which the STA may use.

Since PSNI is based on an internal demodulator parameter, it can be measured and reported on a frame-by-frame basis. BER or FER measurements at points C or E require thousands of frames for accurate measurement. Therefore PSNI is a practical, fast, and available indictor of observed signal quality.

Measurements of analog signal to noise at points A or B can be performed quickly, yet without also knowing the sum of all the implementation losses further downstream, they cannot be accurately related to observed FER at point E.

In these ways, the inventive use of PSNI for network management is more practical to implement, faster to measure, requires no knowledge of STA implementation, and is thus an improvement over the alternatives discussed here.

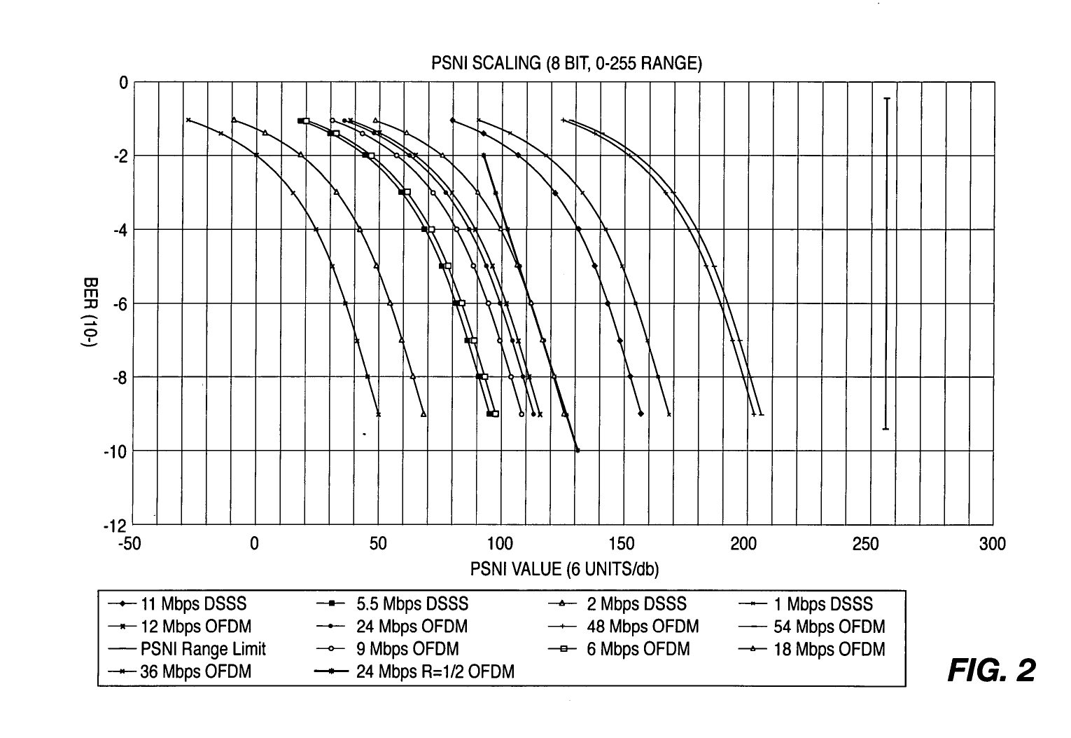

FIG. 2 shows PSNI specified on BER curves in the context of the invention. FIG. 3 illustrates example specification points for a PSNI scaled to a 43 dB range.

The advantages of PSNI over RSSI include the following: The definition of PSNI meets the requirements for RSSI in that the PSNI is an 8-bit unsigned value (for DSSS PHYs) and is proportional to received signal power. PSNI may be reported in any data field calling for RSSI, which makes the PSNI indicator broadly applicable as an interlayer frame quality measurement. PSNI MIB entries and reporting/posting may further be mandated in 802.11 to make the PSNI improvements available to higher layers.

The foregoing is a description of an exemplary embodiment of the PSNI indicator and method of network management. It is envisaged that the invention is applicable to all modes of transmission including TDD, FDD, CDMA, and other modes without exception. It is also conceivable that variations of the described PSNI indicator and method with suitable modifications are conceivable. All such modifications and variations are envisaged to be within the purview of the invention.

What is claimed is:

1. A method for determining a perceived signal to noise indication (PSNI) for management of a wireless network, comprising:
basing the PSNI on a parameter obtained by measuring a signal obtained at a given location in a receiving device; and
specifying a PSNI indicator value with respect to a frame error rate (FER) obtained at the receiving device.

2. The method of claim 1 further comprising:
employing PSNI parameters as a signal quality indicator of one of bit error rate (BER) and frame error rate (FER) to facilitate reconfiguration and management of the network to optimize network performance.

3. The method of claim 1 further comprising:
adjusting the parameter to account for decoder losses of an FEC decoder downstream relative to the measurement point.

4. The method of claim 1 further comprising:
adjusting the parameter to account for losses downstream relative to the measurement point.

5. The method of claim 4 wherein the parameter is obtained from a demodulator in the receiving device.

6. The method of claim 4 wherein the parameter is invariant with respect to data rate.

7. The method of claim 4 wherein the parameter is one of base band phase jitter and base band error vector magnitude.

8. The method of claim 4 wherein the parameter is spreading code correlation quality.

9. The method of claim 1 further comprising:
obtaining the measurement at an output of a receiving antenna for said receiving device.

10. The method of claim 1 wherein the parameter is one of frequency tracking and channel tracking stability.

11. The method of claim 1 wherein the step of specifying the PSNI value further comprises:
specifying PSNI indicator values with respect to the obtained FER at at least one particular data rate/demodulator/forward error correction (FEC) combination point.

12. The method of claim 1 further comprising obtaining the measurement at an internal point of a demodulator provided in the receiving device.

13. The method of claim 1 further comprising obtaining the measurement point at an output of a radio front end which is part of the receiving device.

14. The method of claim 1 further comprising obtaining the measurement at an output of a demodulator provided in the receiving device.

15. The method of claim 1 wherein said PSNI is logarithmically scaled to a perceived signal to noise plus interference value.

16. A method for use in wireless network management, comprising:
determining a perceived signal to noise indication (PSNI) by measuring a signal at an access point (AP) at a receiving location, wherein a signal to noise plus interference value (S/N+I) is determined from a parameter of the measured signal; and
adjusting the parameter to compensate for losses downstream relative to the access point (AP).

17. The method of claim 16 wherein the signal is measured at an AP of a demodulator at said receiving location.

18. The method of claim 16 wherein the signal is measured at an AP of a receiver at said receiving location.

19. The method of claim 16 further comprising:
converting the signal to base band; and
providing automatic gain control to the base band signal to maintain base band power constant.

20. The method of claim 19 wherein the PSNI is obtained after receipt, analog to digital conversion, and demodulation of the signal physical layer (PHY) specific and directly relates to the observed frame error rate obtained from a forward error correction (FEC) decoder.

21. The method of claim 20 wherein a frame error rate (FER) is obtained from a frame check cyclic redundancy check (CRC).

22. Apparatus for management of a wireless network, comprising:
means for determining a perceived signal to noise indication (PSNI) by measuring a signal at an access point (AP), wherein the PSNI is determined based upon a parameter of the signal obtained at said AP; and
means for adjusting the parameter to account for decoder losses downstream relative to the measurement point.

23. The apparatus of claim 22 further comprising means for relating the PSNI value to a frame error rate (FER) obtained downstream relative to said AP.

24. The apparatus of claim 23 wherein the means for relating the PSNI value further comprises:
means for specifying the PSNI values with respect to the obtained FER at at least one particular data rate/demodulator/forward error correction (FEC) combination point.

25. The apparatus of claim 22 wherein said AP is an internal point of a demodulator provided in a receiver.

26. The apparatus of claim 25 wherein said AP is located at an output of a receiving antenna for delivering a received signal to said receiver.

27. The apparatus of claim 25 wherein said AP is located at an output of a radio front end which is part of said receiver.

28. The apparatus of claim 25 wherein said AP is located at an output which is a demodulator of the receiver.

29. The apparatus of claim 22 wherein said PSNI is logarithmically scaled to a perceived signal to noise plus interference value.

30. Apparatus for management of a wireless network, comprising:
means for determining a perceived signal to noise indication (PSNI) by measuring a signal at an access point (AP) wherein a signal to noise plus interference value (S/N+I) is determined from a parameter of said signal in a demodulator receiving said signal; and
means for adjusting the parameter to account for losses downstream relative to the demodulator.

31. The apparatus of claim 30 further comprising:
means for converting the signal to base band; and
means for providing automatic gain control to the base band signal to maintain base band power constant.

32. The apparatus of claim 31 wherein said AP is downstream to a receiver, an analog to digital converter and demodulator and directly relates to an observed frame error rate obtained from a forward error correction (FEC) decoder.

33. The apparatus of claim 32 wherein a frame error rate (FER) is obtained by means employing a frame cyclic redundancy check (CRC).

34. The apparatus of claim 30 wherein the means for adjusting comprises:
means for adjusting the parameter to account for forward error correction decoder losses which occur downstream relative to the demodulator.

35. The apparatus of claim 30 further comprising:
a forward error correction (FEC) decoder;
means for creating a replica of correct input bits inputted to the decoder;
means for comparing the created input bits with corresponding bits inputted to the decoder to determine a bit error rate (BER); and
means responsive to the BER and the FEC decoder output to estimate a frame error rate (FER).

36. The apparatus of claim 30 wherein the parameter is one of base band phase jitter and base band error vector magnitude.

37. The apparatus of claim 30 wherein the parameter is spreading code correlation quality.

38. The apparatus of claim 30 wherein the parameter is one of frequency tracking and channel tracking stability.

39. The apparatus of claim 30 further comprising:
means employing a PSNI obtained as a signal quality indicator of one of bit error rate (BER) and frame error rate (FER) to facilitate reconfiguration and management of the network to optimize network performance.

40. The apparatus of claim 30 wherein said AP is an internal point of a demodulator provided in a receiver.

41. The apparatus of claim 30 wherein said AP is located at an output of a receiving antenna for delivering a received signal to said receiver.

42. The apparatus of claim 30 wherein said AP is located at an output of a radio front end which is part of said receiver.

43. The apparatus of claim 30 wherein said AP is located at an output which is a demodulator of the receiver.
